(19) United States
(12) Patent Application Publication
(10) Pub. No.: US 2026/0121561 A1
(43) Pub. Date: Apr. 30, 2026

(54) MOTOR DRIVER CIRCUIT HAVING DYNAMIC DUTY CYCLE MODULATION MECHANISM

(71) Applicant: ANPEC ELECTRONICS CORPORATION, HSINCHU (TW)

(72) Inventor: KUN-MIN CHEN, HSINCHU CITY (TW)

(21) Appl. No.: 19/012,805

(22) Filed: Jan. 7, 2025

(30) Foreign Application Priority Data
Oct. 29, 2024 (TW) 113141200

(51) Int. Cl. H02P 6/18

(52) U.S. Cl. CPC H02P 6/18; H02P 2209/00

(57) ABSTRACT

A motor driver circuit having a dynamic duty cycle modulation mechanism is provided. The motor driver circuit includes a magnetic field change sensing circuit, a control circuit, a driver circuit and an output stage circuit. The magnetic field change sensing circuit senses a plurality of voltages that are generated with a change in a magnetic field caused by a motor whose rotor is rotating to output a commutation signal. The control circuit sets a plurality of control duty cycles according to the commutation signal. The control circuit outputs a control duty cycle signal according to each of the control duty cycles. The driver circuit outputs a driving signal according to the control duty cycle signal. The output stage circuit operates to output a plurality of output stage signals to the motor according to the driving signal.

### CROSS-REFERENCE TO RELATED PATENT APPLICATION

This application claims the benefit of priority to Taiwan Patent Application No. 113141200, filed on Oct. 29, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a motor, and more particularly to a motor driver circuit having a dynamic duty cycle modulation mechanism.

### BACKGROUND OF THE DISCLOSURE

With the rapid advancements in technology, mobile devices have become increasingly popular. As these devices evolve toward miniaturization, thin profiles, and enhanced functionality, the demand for efficient heat dissipation solutions has grown significantly. Millimeter-sized micro fans, also known as “Mighty Mini Fans,” have emerged as a promising option for next-generation portable products, including gaming phones, mobile devices, computers, consumer electronics, and medical devices. These micro fans are exceptionally compact and precise, with dimensions as small as 9×9×3 mm, inductance levels of approximately 40 μH, and resistance values of up to 200 ohms. However, traditional motor driver circuits often produce substantial current ripple when driving these fans, leading to operating noise levels that exceed acceptable thresholds for high-performance devices.

### SUMMARY OF THE DISCLOSURE

In response to the above-referenced technical inadequacies, the present disclosure provides a motor driver circuit having a dynamic duty cycle modulation mechanism. The motor driver circuit of the present disclosure includes a magnetic field change sensing circuit, a control circuit, a driver circuit, and an output stage circuit. The magnetic field change sensing circuit is disposed on the motor. The magnetic field change sensing circuit is configured to sense a plurality of voltages that are generated with a change in a magnetic field caused by a motor whose rotor is rotating to output a commutation signal. The control circuit is connected to the magnetic field change sensing circuit and is configured to set a plurality of control duty cycles according to the commutation signal, and to output a control duty cycle signal according to each control duty cycle. The driver circuit is connected to the control circuit and the motor, and is configured to output a driving signal based on the control duty cycle signal. The output stage circuit is connected to the driver circuit and the motor and operates according to the driving signal to output the plurality of output stage signals to the motor.

As described above, the present disclosure introduces a motor driver circuit featuring a dynamic duty cycle modulation mechanism. In contrast to traditional motor driver circuits, which often result in ripple in the current signal flowing through the motor and produce significant operational noise, the motor driving mechanism employed in the present disclosure mitigates ripple in the current signal. This reduction in ripple significantly lowers the noise generated during motor operation.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a block diagram of a motor driver circuit having a dynamic duty cycle modulation mechanism according to a first embodiment of the present disclosure;

FIG. 2 is a block diagram of a motor driver circuit having a dynamic duty cycle modulation mechanism according to a second embodiment of the present disclosure;

FIG. 3 is a waveform diagram of the signal in the motor driver circuit having a dynamic duty cycle modulation mechanism according to the second embodiment of the present disclosure;

FIG. 4 is a waveform diagram of the signal in the motor driver circuit having a dynamic duty cycle modulation mechanism according to the second embodiment of the present disclosure; and

FIG. 5 is a block diagram of a motor driver circuit having a dynamic duty cycle modulation mechanism according to a third embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

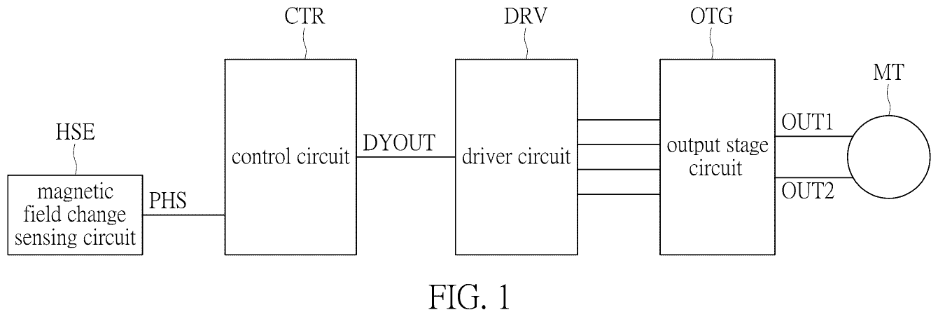

Please refer to FIG. 1, which shows a block diagram of the motor driver circuit having a dynamic duty cycle modulation mechanism in the first embodiment of the present disclosure.

The motor driver circuit having a dynamic duty cycle modulation mechanism in the present disclosure includes a magnetic field change sensing circuit HSE, a control circuit CTR, a driver circuit DRV, and an output stage circuit OTG.

The magnetic field change sensing circuit HSE is installed on the motor MT. The magnetic field change sensing circuit HSE may include a Hall sensor. The magnetic field change sensing circuit HSE is configured to detect the plurality of voltages (including both positive and negative voltages) generated due to variations in magnetic intensity as the rotor of the motor MT rotates, thereby outputting a commutation signal PHS.

The control circuit CTR is connected to the magnetic field change sensing circuit HSE. Based on the commutation signal PHS received from the magnetic field change sensing circuit HSE, the control circuit CTR sets the plurality of control duty cycles.

For instance, the control circuit CTR may compare the plurality of voltages of the commutation signal PHS at the plurality of time points with a commutation reference voltage to generate a comparison result. Based on this comparison result, the control circuit determines the plurality of modulation duty cycles, and based on the plurality of modulation duty cycles along with a plurality of indicative duty cycles received from an external pulse width modulation signal generator, the plurality of control duty cycles are determined. For instance, the control circuit CTR detects the plurality of duty cycles of a pulse width modulation signal output by the external pulse width modulation signal generator as a plurality of indicative duty cycles. The control circuit CTR may then multiply each of the plurality of modulation duty cycles by each of the plurality of duty cycles of the pulse width modulation signal to calculate a plurality of ratios, which serve as the plurality of control duty cycles.

The control circuit CTR then outputs a control duty cycle output signal DYOUT based on each control duty cycle. The driver circuit DRV is connected to the control circuit CTR and the motor MT. The driver circuit DRV sets and outputs the plurality of driving signals according to the plurality of control duty cycles indicated by the control duty cycle output signal DYOUT received from the control circuit CTR.

The output stage circuit OTG is connected to the driver circuit DRV and the motor MT. The output stage circuit OTG operates according to the plurality of driving signals from the driver circuit DRV to output the plurality of output stage signals to the plurality of terminals of the motor MT (for example, but not limited to, the first terminal OUT1 and second terminal OUT2 of a single-phase motor) for driving the motor MT. Each output stage signal from the output stage circuit OTG can include various waveforms, such as sinusoidal waveforms, third harmonic waveforms, or trapezoidal waveforms, but the present disclosure is not limited thereto.

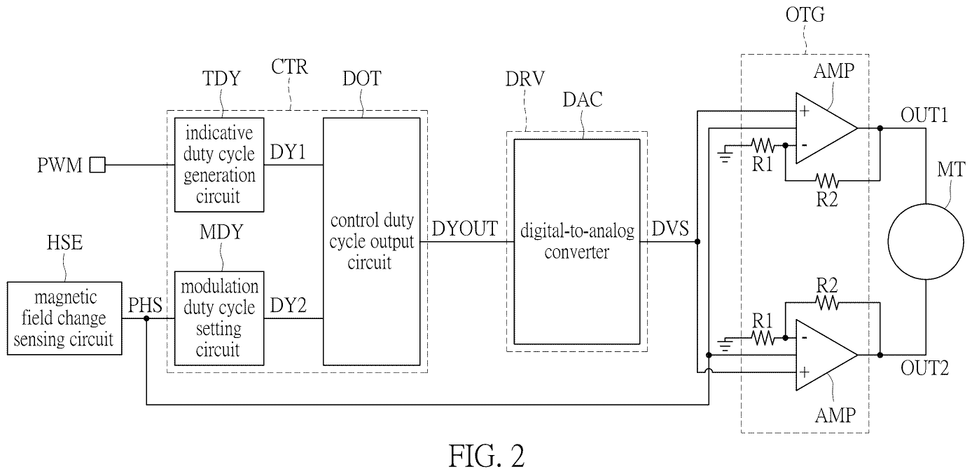

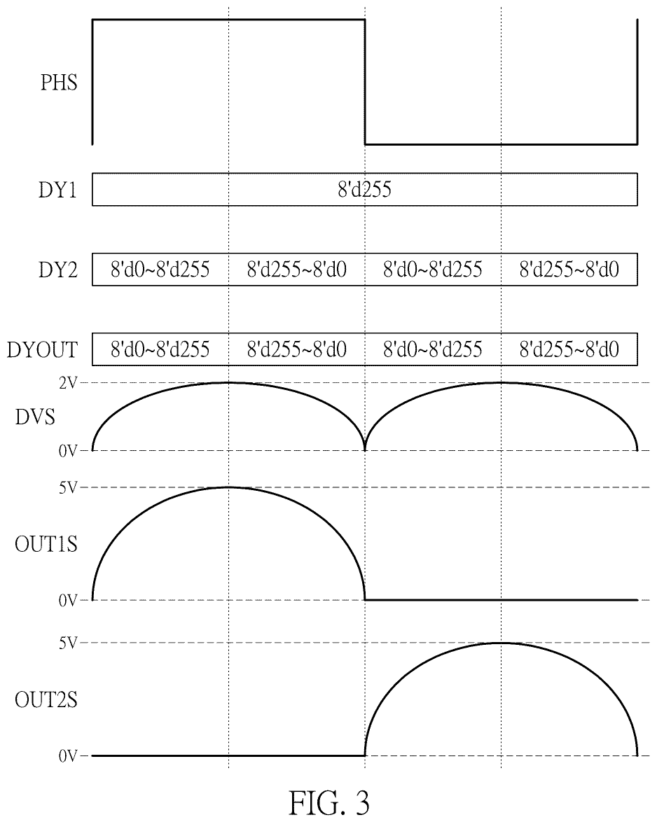

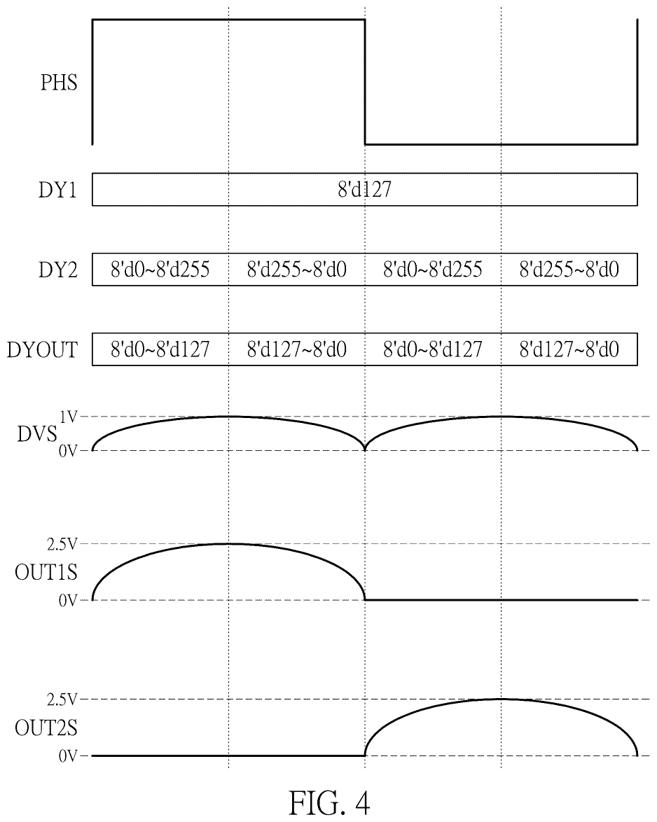

Please refer to FIGS. 2 through 4, where FIG. 2 shows a block diagram of the motor driver circuit having a dynamic duty cycle modulation mechanism according to the second embodiment of the present disclosure, and FIGS. 3 and 4 illustrate waveform diagrams of the signals in the motor driver circuit according to the second embodiment of the present disclosure.

The motor driver circuit having a dynamic duty cycle modulation mechanism in the present disclosure includes a magnetic field change sensing circuit HSE, a control circuit CTR, a driver circuit DRV, and an output stage circuit OTG.

As shown in FIG. 2, the control circuit CTR may include an indicative duty cycle generation circuit TDY, a modulation duty cycle setting circuit MDY, and a control duty cycle output circuit DOT. The driver circuit DRV may include a digital-to-analog converter DAC. The output stage circuit OTG may include one or more operational amplifiers, such as the two operational amplifiers AMP shown in FIG. 2, as well as the plurality of first feedback resistances R1 and the plurality of second feedback resistances R2. This is provided for illustration only and is not intended to limit the present disclosure.

As shown in FIG. 2, the input terminal of the modulation duty cycle setting circuit MDY is connected to the output terminal of the magnetic field change sensing circuit HSE. The input terminal of the control duty cycle output circuit DOT is connected to the output terminal of the duty cycle generation circuit TDY, the output terminal of the modulation duty cycle setting circuit MDY, and the input terminal of the digital-to-analog converter DAC.

Each operational amplifier AMP has a first input terminal, such as a non-inverting input, a second input terminal, such as an inverting input, and an output terminal. The first input terminal of each operational amplifier AMP, for instance, the non-inverting input, is connected to the digital-to-analog converter DAC. The second input terminal of each operational amplifier AMP, for instance, the inverting input, is coupled to a reference voltage.

The first terminal of each first feedback resistance R1 is grounded. The second terminals of the plurality of first feedback resistances R1 are respectively connected to the first terminals of the plurality of second feedback resistances R2. The second terminals of the plurality of second feedback resistances R2 are connected to the output terminals of the plurality of operational amplifiers AMP. The voltage at the nodes between the second terminal of each first feedback resistance R1 and the first terminal of each second feedback resistance R2 serves as the reference voltage mentioned above.

The output terminals of the plurality of operational amplifiers AMP are connected to the plurality of terminals of the motor MT (such as, but is not limited to the first terminal OUT1 and second terminal OUT2 of a single-phase motor). If necessary, each operational amplifier AMP may further include a third input terminal connected to the output terminal of the magnetic field change sensing circuit HSE.

The duty cycle generation circuit TDY outputs the plurality of indicative duty cycles DY1. For instance, the duty cycle generation circuit TDY detects the plurality of duty cycles of pulse width modulation signals output from an external pulse width modulation signal generator (not shown in the figure) as the plurality of indicative duty cycles DY1.

The magnetic field change sensing circuit HSE senses the plurality of voltages (including both positive and negative voltages) generated by variations in magnetic intensity during the rotation of the rotor of the motor MT to output a commutation signal PHS. The commutation signal PHS shown in FIG. 2 is similar to the commutation signal PHS shown in FIG. 3 or 4. The modulation duty cycle setting circuit MDY then sets the plurality of modulation duty cycles DY2 according to the commutation signal PHS received from the magnetic field change sensing circuit HSE.

For example, the modulation duty cycle setting circuit MDY receives a commutation signal PHS from the magnetic field change sensing circuit HSE, which is a voltage signal with the plurality of waveforms. The modulation duty cycle setting circuit MDY may compare the plurality of voltages of the commutation signal PHS waveforms at the plurality of time points with a commutation reference voltage to determine the plurality of levels of a modulation duty cycle signal at the plurality of time points. Subsequently, the modulation duty cycle setting circuit MDY sets the plurality of modulation duty cycles DY2 based on the plurality of phase times (including the plurality of active cycles and inactive cycles) of the modulation duty cycle signal's waveforms.

For instance, the modulation duty cycle setting circuit MDY can store the plurality of reference phase times and corresponding reference modulation duty cycles DY2. The modulation duty cycle setting circuit MDY can obtain a reference modulation duty cycle DY2 corresponding to a reference phase time that matches the phase time of a modulation duty cycle signal mentioned above, and the reference modulation duty cycle DY2 is used as a modulation duty cycle DY2. In this way, the modulation duty cycle setting circuit MDY can obtain the plurality of modulation duty cycles DY2 corresponding to each phase time of a modulation duty cycle signal.

Furthermore, the control duty cycle output circuit DOT sets the plurality of control duty cycles (or, as stated, the plurality of control duty cycle values) based on the plurality of indicative duty cycles DY1 received from the indicative duty cycle generation circuit TDY and the plurality of modulation duty cycles DY2 received from the modulation duty cycle setting circuit MDY. Each indicative duty cycle DY1, for example, may be a value of 255 corresponding to a 100% duty cycle or a value of 127 corresponding to a 50% duty cycle, as shown in FIG. 3. The plurality of modulation duty cycles DY2 in FIG. 2 can correspond to the plurality of values, as shown in FIG. 3 or FIG. 4. Note that 8d represents 8 bits, as depicted in FIG. 3 or FIG. 4.

For example, the control duty cycle output circuit DOT can multiply a modulation duty cycle (a ratio, such as, but is not limited to 50%) by an indicative duty cycle (a ratio, such as, but is not limited to 100%) obtained within the same time interval to compute a ratio used as a control duty cycle. In other words, the control duty cycle output circuit DOT multiplies each modulation duty cycle DY2 by each indicative duty cycle DY1 to compute the plurality of ratios as the plurality of control duty cycles.

Alternatively, the control duty cycle output circuit DOT may set duty cycles ranging from 0% to 100%, corresponding to a range of values from 0 to 225, as shown in FIG. 3 or FIG. 4. The control duty cycle output circuit DOT multiplies a value corresponding to a modulation duty cycle DY2 obtained from the modulation duty cycle setting circuit MDY (e.g. a value of 255 corresponding to 100%) by a value corresponding to an indication duty cycle (e.g. a value of 255 corresponding to 50%). The product is then divided by the value (e.g. 255) corresponding to the maximum duty cycle (e.g. 100%) to calculate a value that serves as a control duty cycle value.

The control duty cycle output circuit DOT outputs a control duty cycle output signal DYOUT based on each control duty cycle or control duty cycle value determined above.

The driver circuit DRV outputs a driving signal DVS based on the control duty cycle output signal DYOUT received from the control duty cycle output circuit DOT. The driving signal DVS, as shown in FIG. 2, can correspond to the driving signal DVS illustrated in FIG. 3 or FIG. 4.

If the control duty cycle output signal DYOUT from the control duty cycle output circuit DOT is a digital signal, the driver circuit DRV may include a digital-to-analog converter DAC to convert the control duty cycle output signal DYOUT from a digital signal to an analog signal for serving as the driving signal DVS.

The first input terminal of each operational amplifier AMP, e.g., the non-inverting input, receives a driving signal DVS from the driver circuit DRV. The second input terminal of each operational amplifier AMP, e.g., the inverting input, receives a reference voltage from the node between the first terminal of the second feedback resistance R2 and the second terminal of the first feedback resistance R1. The third input terminal of each operational amplifier AMP receives a commutation signal PHS from the magnetic field change sensing circuit HSE.

Each operational amplifier AMP multiplies the difference between each voltage of the driving signal DVS or commutation signal PHS waveforms and the reference voltage by a preset gain to generate an operational amplification signal. The plurality of operational amplifiers AMP output the generated operational amplification signals to the plurality of terminals of the motor MT, such as the first terminal OUT1 and second terminal OUT2, to drive the motor MT.

By adjusting the duty cycle of a pulse width modulation signal PWM output from an external pulse width modulation signal generator (not shown in the figure), the voltage signals at the first terminal OUT1 and second terminal OUT2 of the motor MT can be controlled.

For instance, the voltage signal at the first terminal OUT1 of the motor MT may correspond to the voltage signal OUT1S shown in FIG. 3 or FIG. 4, and the voltage signal at the second terminal OUT2 of the motor MT may correspond to the voltage signal OUT2S shown in FIG. 3 or FIG. 4.

The amplitude of the voltage signal on the coil between the first terminal OUT1 and the second terminal OUT2 of the motor MT can range from −VCC×DTPWM to VCC×DTPWM, where VCC represents the power supply voltage (the power supply voltage connected to the positive power input terminal of the driver circuit DRV, the output stage circuit OTG, or each operational amplifier AMP), and DTPWM is the duty cycle of the pulse width modulation signal PWM. If VCC=5V and pulse width modulation PWM=100%, as shown in FIG. 3, then the amplitude of V(OUT1)−V(OUT2) is −5V to 5V. If VCC=5V and pulse width modulation PWM=50%, as shown in FIG. 4, then the amplitude of V(OUT1)−V(OUT2) is −2.5V to 2.5V.

It should be noted that, as shown in FIG. 3 or FIG. 4, the driving signal DVS output from the driver circuit DRV in the motor driver circuit of the present disclosure, as well as the voltage signals OUT1S and OUT2S at the first terminal OUT1 and second terminal OUT2 of the motor MT, have no ripple. Therefore, the motor driver circuit of the present disclosure can stably drive the motor MT.

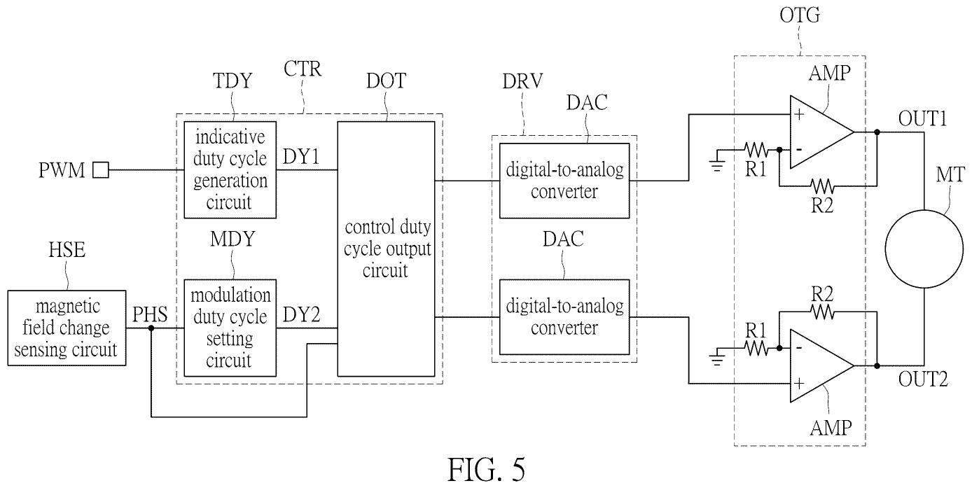

Please refer to FIG. 5, which is a block diagram of the motor driver circuit having a dynamic duty cycle modulation mechanism in the third embodiment of the present disclosure.

The similarities between the third embodiment of the present disclosure and the second embodiment are not reiterated here.

The difference between the third embodiment and the second embodiment of the present disclosure lies in the fact that the driver circuit DRV in the motor driver circuit of the second embodiment of the present disclosure, as shown in FIG. 2, includes only a single digital-to-analog converter DAC. In contrast, the driver circuit DRV in the motor driver circuit of the third embodiment of the present disclosure, as shown in FIG. 5, includes the plurality of digital-to-analog converters DAC.

In the third embodiment, the control duty cycle output circuit DOT sets the plurality of control duty cycles (or, as described above, the plurality of control duty cycle values) based on the plurality of indicative duty cycles DY1 received from the indicative duty cycle generation circuit TDY and the plurality of modulation duty cycles DY2 received from the modulation duty cycle setting circuit MDY. The control duty cycle output circuit DOT outputs the plurality of control duty cycle output signals DYOUT according to each control duty cycle or control duty cycle value, respectively, to the plurality of digital-to-analog converters DAC.

Each digital-to-analog converter DAC is configured to convert the plurality of control duty cycle output signals DYOUT from the plurality of digital signals into the plurality of analog signals, which serve as the plurality of driving signals DVS. These signals are then output to the plurality of first input terminals, e.g., the non-inverting input terminals, of the plurality of operational amplifiers AMP.

In summary, the present disclosure provides a motor driver circuit having a dynamic duty cycle modulation mechanism. Compared to the motor driving mechanisms used in traditional motor driver circuits, which create ripple in the current signal passing through the motor and result in high noise during motor operation, the motor driving mechanism of the present disclosure does not produce ripple in the current signal flowing through the motor, thereby reducing the noise generated during motor operation.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A motor driver circuit having a dynamic duty cycle modulation mechanism, comprising:
a magnetic field change sensing circuit disposed on a motor, and configured to sense a plurality of voltages that are generated with a change in a magnetic field caused by a motor whose rotor is rotating to output a commutation signal;
a control circuit connected to the magnetic field change sensing circuit, and configured to set a plurality of control duty cycles based on the commutation signal and output a control duty cycle signal based on each of the plurality of control duty cycles;
a driver circuit connected to the control circuit and the motor, and configured to output a driving signal based on the control duty cycle signal; and
an output stage circuit connected to the driver circuit and the motor, and configured to operate based on the driving signal to output a plurality of output stage signals to the motor.

2. The motor driver circuit according to claim 1, wherein the control circuit is configured to compare the plurality of voltages of the commutation signal with a commutation reference voltage to determine a plurality of modulation duty cycles and to determine the plurality of control duty cycles based on the plurality of modulation duty cycles and a plurality of duty cycles of a pulse width modulation signal.

3. The motor driver circuit according to claim 2, wherein the control circuit is configured to multiply each of the plurality of modulation duty cycles by each of the plurality of duty cycles of the pulse width modulation signal to calculate the plurality of control duty cycles.

4. The motor driver circuit according to claim 1, wherein the control circuit comprises:
an indicative duty cycle generation circuit configured to output a plurality of indicative duty cycles;
a modulation duty cycle setting circuit connected to the magnetic field change sensing circuit, and configured to set the plurality of modulation duty cycles based on the commutation signal; and
a control duty cycle output circuit connected to the indicative duty cycle generation circuit and the modulation duty cycle setting circuit, and configured to set the plurality of control duty cycles based on the plurality of indicative duty cycles and the plurality of modulation duty cycles.

5. The motor driver circuit according to claim 4, wherein the indicative duty cycle generation circuit is configured to detect a plurality of duty cycles of a plurality of pulses of a pulse width modulation signal output by an external pulse width modulation signal generator as the plurality of indicative duty cycles.

6. The motor driver circuit according to claim 4, wherein the control duty cycle output circuit multiplies each of the plurality of modulation duty cycles by each of the plurality of indicative duty cycles to respectively obtain the plurality of control duty cycles.

7. The motor driver circuit according to claim 4, wherein the modulation duty cycle setting circuit is configured to compare each of the plurality of voltages of the commutation signal at a plurality of time points with the commutation reference voltage to determine a plurality of levels of a modulation duty cycle signal at the plurality of time points, and to set the plurality of modulation duty cycles based on a plurality of phase times of a plurality of waveforms of the modulation duty cycle signal, wherein the plurality of phase times includes a plurality of on-duty cycles and a plurality of off-duty cycles of the plurality of waveforms.

8. The motor driver circuit according to claim 7, wherein the modulation duty cycle setting circuit is configured to store a plurality of reference phase times and a plurality of reference modulation duty cycles corresponding to the plurality of reference phase times, and to use a reference modulation duty cycle corresponding to a reference phase time identical to phase time of the modulation duty cycle signal as the modulation duty cycle.

9. The motor driver circuit according to claim 1, wherein the output stage circuit comprises:
a plurality of operational amplifiers, wherein each of plurality of operational amplifiers has a first input terminal, a second input terminal, and an output terminal, wherein the first input terminal of each of the plurality of operational amplifiers is connected to the driver circuit to receive the driving signal, the second input terminal of each of the plurality of operational amplifiers is coupled to a reference voltage, and output terminals of the plurality of operational amplifiers are respectively connected to a plurality of terminals of the motor.

10. The motor driver circuit according to claim 9, wherein each of the plurality of operational amplifiers further comprises a third input terminal, and the third input terminal of each of the plurality of operational amplifiers is connected to the magnetic field change sensing circuit and configured to receive the commutation signal from the magnetic field change sensing circuit.

11. The motor driver circuit according to claim 9, wherein the output stage circuit further comprises:
a plurality of first feedback resistances, wherein each of the plurality of first feedback resistances has a first terminal and a second terminal, wherein the first terminal of each of the plurality of first feedback resistances is connected to ground and second terminals of the plurality of first feedback resistances are respectively connected to second input terminals of the plurality of operational amplifiers, and the voltage at the second terminal of each of the plurality of first feedback resistances serves as the reference voltage; and
a plurality of second feedback resistances, wherein first terminals of the plurality of second feedback resistances are respectively connected to the second terminals of the plurality of first feedback resistances, and second terminals of the plurality of second feedback resistances are respectively connected to the output terminals of the plurality of operational amplifiers.

12. The motor driver circuit according to claim 9, wherein the driver circuit comprises:
a digital-to-analog converter, wherein an input terminal of the digital-to-analog converter is connected to an output terminal of the control circuit, and an output terminal of the digital-to-analog converter is connected to the first input terminal of each of the plurality of operational amplifiers.

13. The motor driver circuit according to claim 9, wherein the driver circuit comprises:
a plurality of digital-to-analog converters, wherein input terminals of the plurality of digital-to-analog converters are connected to the output terminal of the control circuit, and the input terminals of the plurality of digital-to-analog converters are respectively connected to the first input terminals of the plurality of operational amplifiers.
